(19) United States
(12) Patent Application Publication
(10) Pub. No.: US 2010/0313643 A1
(43) Pub. Date: Dec. 16, 2010

(54) Blood flow simulation system

(76) Inventors: Liang-Yu Shyu, Chung Li (TW); Wei-Chih Hu, Chung Li (TW); Wen-Yao Chung, Chung Li (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/654,130

(22) Filed: Dec. 11, 2009

(30) Foreign Application Priority Data
Jun. 12, 2009 (TW) 098119843

(51) Int. Cl. G01D 21/00

(52) U.S. Cl. 73/118.01

(57) ABSTRACT

The present invention relates to a blood flow simulation system, which comprises a first container, a phantom, and a second container. The blood flow simulation system according to the present invention contains a fluid by the first container. Then the phantom is used for transporting the fluid. Afterwards, the second container is used for containing the fluid output by the phantom, and transporting the fluid to the first container by way of the phantom. Thereby, the blood-vessel characteristics, the blood-flow characteristics, and the human muscle characteristics can be simulated effectively and hence facilitating experimental convenience.

### FIELD OF THE INVENTION

The present invention relates to a simulation system, and particularly to a blood flow simulation system.

### BACKGROUND OF THE INVENTION

Owing to the continuing increase in gross national product (GNP), the aging population structure, and the introduction of novel medical technologies, people's demand in health care increases year by year, which promotes the growth of related medicine and sanitary industries. In particular, the growth potential of the industry of domestic medical care devices attracts substantial attention. Hypertension is always one of the domestic ten leading causes of death. For preventing hypertension, in addition to diet control, an electronic hemadynamometer (blood pressure monitor) has become a necessary homecare product using simple operations requiring no professional skill.

Blood pressure (BP) and blood-pressure waveforms are indicators for evaluating heart functions. Many physiological reactive mechanisms will influence blood pressure and blood-pressure waveforms. Current automatic blood pressure measuring devices use the oscillometric method as the basis. According to the prior art, the pressure modulation system in the calibration apparatus of an oscillometric-based automatic blood pressure measuring device performs calibration by modulating the pressure of the cuff directly'. The calibration apparatus can only calibrate the pressure sensor and electric circuits of the device, but not the influences caused by human muscles, blood-vessel characteristics, and the cuff Namely, the calibration of the blood-pressure measurement system cannot be performed using the typical noninvasive blood-pressure measuring method. This is because the common noninvasive blood-pressure measuring method is not a continuous measuring method, and hence there is time synchronization problem during calibration. In addition, a general noninvasive calibration method cannot control the testing conditions freely. Moreover, after the control mechanism of the cuff is started, the compensation mechanism of the relative change in the blood-pressure waveform cannot be performed without the calibration information.

Accordingly, the present invention provides a blood flow simulation system for solving the problems described above. According to the present invention, a phantom imitating a human upper limb is used and is equipped with simulated blood vessels with characteristics close to human blood vessels. Then a pump and sinks are used form a close loop for simulating the blood-vessel circuit of a human body. Thereby, the blood-vessel characteristics, blood-flow characteristics, and human-muscle characteristics can be modulated to make the calibration of blood-pressure measurement more precise and realistic. Hence, the disadvantages of the prior art as described above can be improved then increased the precision of blood-pressure calibration.

### SUMMARY

One of the objective of the present invention is to provide a blood flow simulation system, which uses a first container, a phantom, and a second container to simulate the blood-vessel system of a human body. Thereby, the blood-vessel characteristics, the blood-flow characteristics, and the human muscle characteristics can be simulated effectively and hence facilitating experimental convenience.

Another objective of the present invention is to provide a blood flow simulation system, which can provide various systolic and diastolic pressures and waveforms of basic blood pressure for researches using various noninvasive blood-pressure measurement systems or for calibration of a blood-pressure measuring device.

Still another objective of the present invention is to provide a blood flow simulation system, which can replace artificial blood vessels according to different demands. Thereby, the calibration scenario close to a realistic human body can be imitated.

The blood flow simulation system according to the present invention comprises a first container, a phantom, and a second container. The first container is used for containing a fluid. The phantom is used for transporting the fluid. The second container contains the fluid output by the phantom, and transports the fluid to the first container by way of the phantom. The present invention uses the first container, the phantom, and the second container to simulate the blood-vessel system of a human body. Thereby, the blood-vessel characteristics, the blood-flow characteristics, and the human muscle characteristics can be simulated effectively and hence facilitating experimental convenience. The first and second containers according to the present invention include a housing and a buffer structure. The housing is used for containing the fluid. The buffer structure is set in the housing for buffering the fluid.

The blood flow simulation system according to the present invention further comprises a first pressure adjustment unit, a second pressure adjustment unit, and a control unit. The first pressure adjustment unit is set between the first container and the phantom, and transports the fluid according a first pressure value. The second pressure adjustment unit is set between the phantom and the second container, and transports the fluid according a second pressure value. The control unit is connected to the first pressure adjustment unit and the second pressure adjustment unit, and controls the values of the first pressure value and the second pressure value. Thereby, the present invention can provide various systolic and diastolic pressures and waveforms of basic blood pressure for researches using various noninvasive blood-pressure measurement systems or for calibration of a blood-pressure measuring device.

The blood flow simulation system according to the present invention further comprises multiple pressure sensors. These pressure, sensors senses the first pressure value and the second pressure value, respectively, produces a first sensing signal and a second sensing signal, and transmits the first and second sensing signals to the control unit. Besides, the blood flow simulation system according to the present invention further comprises a flow meter, which senses the flow rate in the phantom, produces a third sensing signal, and transmits the third sensing signal to the control unit. Thereby, the blood-pressure measuring device can be calibrated.

### BRIEF DESCRIPTION OF THE DRAWINGS

FIG. 1 shows a block diagram of a blood flow simulation system according to a preferred embodiment of the present invention;

FIG. 2 shows a structural schematic diagram of the blood flow simulation system in FIG. 1 according to a preferred embodiment of the present invention;

FIG. 3 shows a structural schematic diagram of a first container according to a preferred embodiment of the present invention;

FIG. 4 shows a block diagram of a blood flow simulation system according to another preferred embodiment of the present invention;

FIG. 5 shows a structural schematic diagram of the blood flow simulation system in FIG. 4 according to a preferred embodiment of the present invention; and

FIG. 6 shows a schematic diagram of controlling the first pressure adjustment unit according to a preferred embodiment of the present invention.

### DETAILED DESCRIPTION

In order to make the structure and characteristics as well as the effectiveness of the present invention to be further understood and recognized, the detailed description of the present invention is provided as follows along with preferred embodiments and accompanying figures.

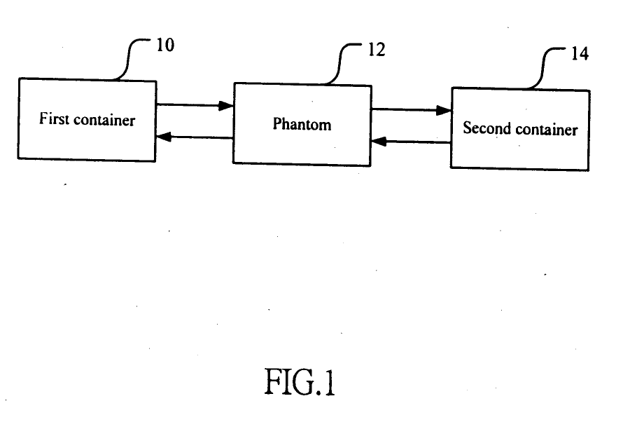

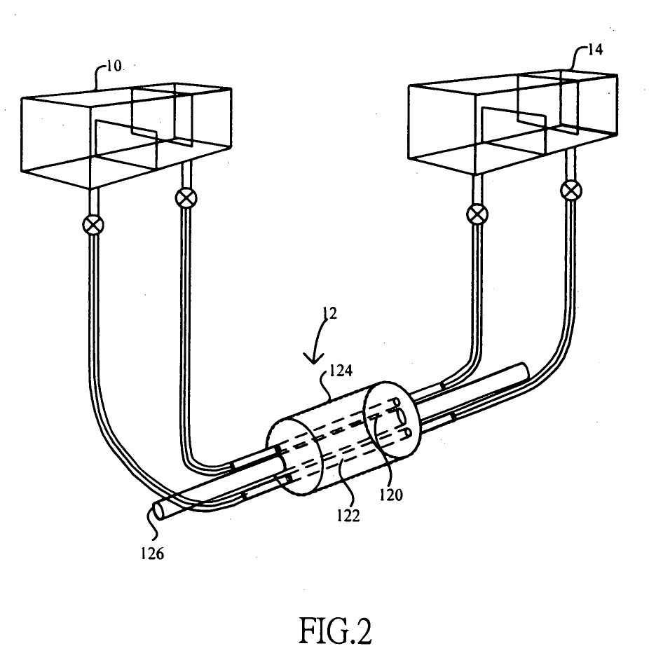

FIG. 1 and FIG. 2 show a block diagram and a structural schematic diagram of a blood flow simulation system according to a preferred embodiment of the present invention. As shown in the figures, the blood flow simulation system according to the present invention comprises a first container 10, a phantom 12, and a second container 14. The first container 10 is used for containing a fluid. According to the present preferred embodiment, water is chosen as the fluid for simulating the blood. However, the fluid is not limited to water. Other liquids can be chosen as well. The phantom 12 is used for transporting the fluid. The second container 14 contains the fluid output by the phantom 12, and transports the fluid. to the first container 10 by way of the phantom 12. The phantom 12 includes a first artificial blood vessel 120, a second artificial blood vessel 122, and a contact part 124. One end of the first artificial blood vessel 120 is connected to the first container 10. The other end thereof is connected to the second container 14. Thereby, the fluid can be transported from the first container 10 to the second container 14. In addition, one end of the second artificial blood vessel 122 is connected to the first container 10. The other end thereof is connected to the second container 14. Thereby, the fluid can be transported from the second container 14 to the first container 10. The contact part 124 is used for covering the first artificial blood vessel 120 and the second artificial blood vessel 122. Hence, by connecting the first artificial blood vessel 120 and the second artificial blood vessel 122 between the first container 10 and the second container 14, the blood-vessel system of a human body can be simulated. Besides, the first and second containers 10, 14 are airtight containers. According to the present invention, by controlling the internal pressures of the first and the second containers 10, 14, the blood-vessel characteristics and the blood-flow characteristics can be simulated, providing experimental convenience. The blood flow simulation system according to the present invention also provides basic blood-pressure waveforms for researches of different noninvasive blood-pressure measurement systems.

The first and second artificial blood vessels 120, 122 are rubber tubes or polymer tubes. The contact part 124 according to the present invention is made from silicone elastomer or gels for simulating muscle characteristics of a human body. In addition, the first and second artificial blood vessels 120, 122 according to the present invention can be replaced by artificial blood vessels with different characteristics according to various demands. Thereby, the calibration scenario close to the realistic human body can be imitated.

The blood flow simulation system according to the present invention further comprises a support 126, passing through the phantom 12 for supporting the phantom 12 and simulating the skeleton of a human body supporting the muscles.

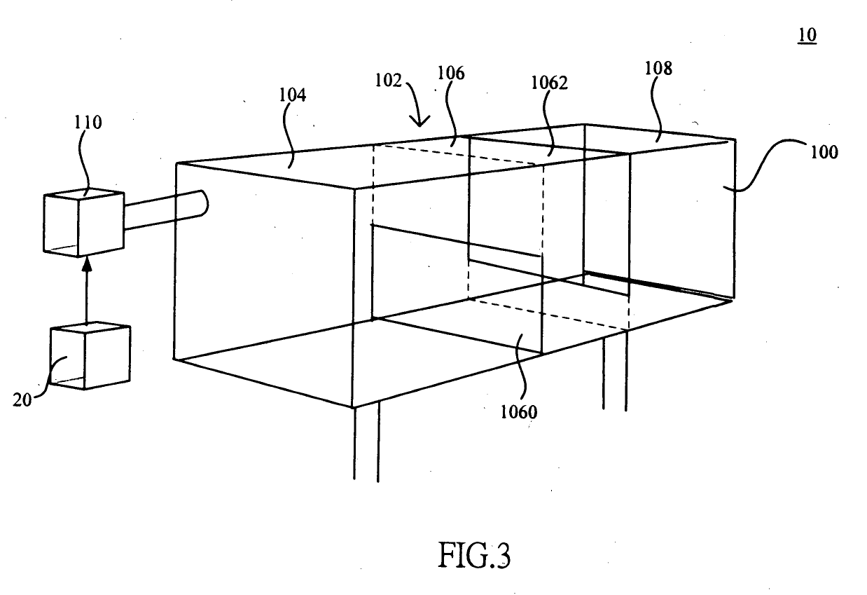

FIG. 3 shows a structural schematic diagram of a first container according to a preferred embodiment of the present invention. As shown in the figure, the first container 10 according to the present invention includes a housing 100 and a buffer structure 102. The housing 100 is used for containing the fluid. The buffer structure 102 is set in the housing 100 for buffering the fluid. That is to say, the first container 10, by means of the buffer structure 102, is divided into an inlet zone 104, a buffer zone 106, and an outlet zone 108. The second artificial blood vessel 122 waters the inlet zone 104 of the first container 10. The buffer zone 106 buffers the fluid for reducing the influence of backflow from the inlet zone 104. The outlet zone 108 waters the first artificial blood vessel 120.

The buffer structure 106 includes a first partition 1060 and a second partition 1062. The first partition 1060 is set in the housing 100, and is located at the bottom inside the housing 100. The second partition 1062 is set in the housing 100, and is located at the top inside the housing 100. In addition, the first and the second partitions 1060, 1062 are separated by a distance. Thereby, the fluid in the inlet zone 104 of the first container 10 enters the buffer zone 106 via the path above the first partition 1060. The fluid in the buffer zone 106 enters the outlet zone 108 via the path under the second partition 1062. Hence buffering of the fluid can be achieved, and the influence of backflow from the inlet zone 104 can be reduced.

Moreover, the first container 10 according to the present invention further includes a pressure-producing unit 110. The pressure-producing unit 110 is connected to the housing 100 for providing a pressure to the housing 100. Thereby, the pressure of the first container 10 can be changed by means of the pressure-producing unit 110. Besides, the blood flow simulation system according to the present invention further comprises a control unit 20. The control unit 20 is coupled to the pressure-producing unit 110 for controlling the pressure produced by the pressure-producing unit 110. The pressure-producing unit 110 produces air pressure for the first container 10. Likewise, the second container 14 has an identical structure as the first container 10, and will not be described in detail.

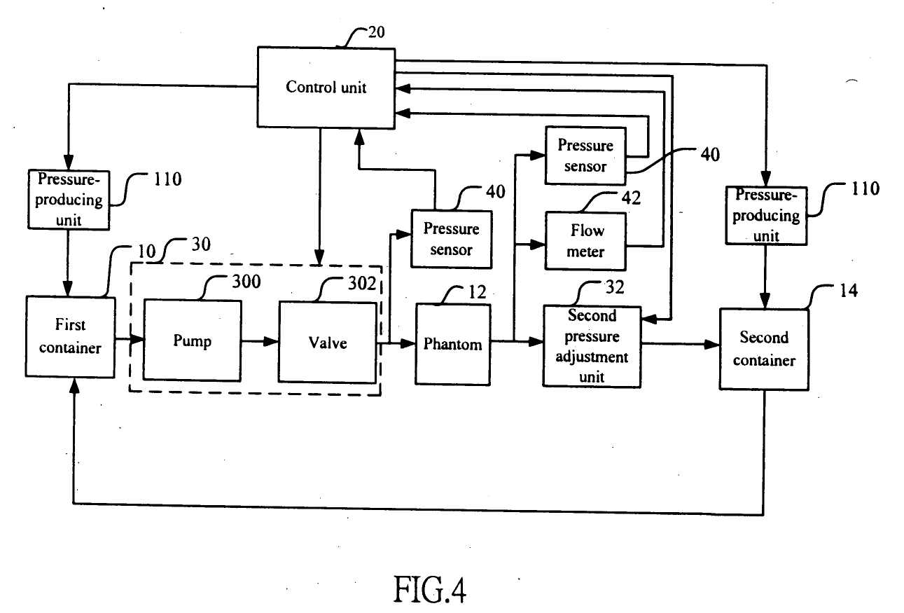

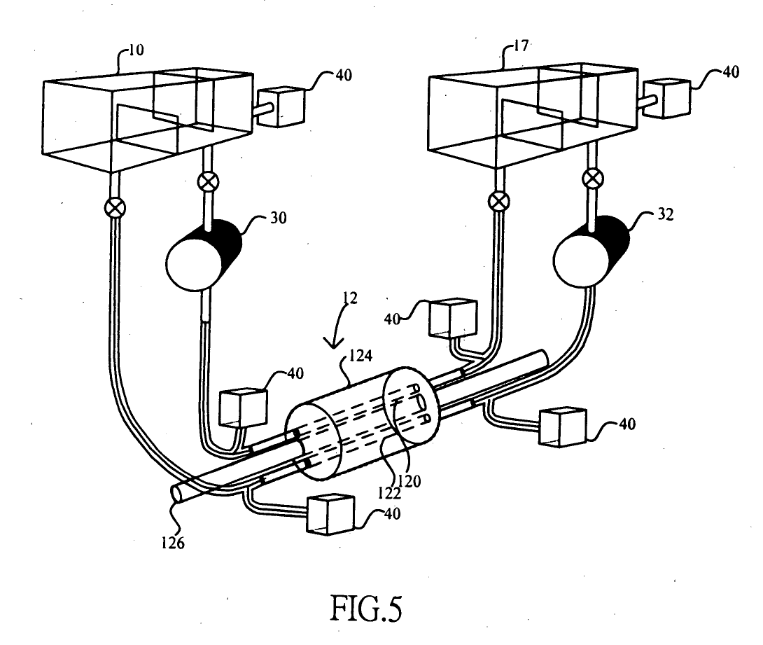

FIG. 4 and FIG. 5 show a block diagram and a structural schematic diagram of a blood flow simulation system according to another preferred embodiment of the present invention. As shown in the figures, the differences between the present preferred embodiment and the one in FIG. 1 and FIG. 2 is that, the blood flow simulation system according to the present preferred embodiment further comprises a first pressure adjustment unit 30 and a second pressure adjustment unit 32. The first pressure adjustment unit 30 is set between the first container 10 and the phantom 12, and transports the fluid according a first pressure value. The control unit 20 is connected to the first pressure adjustment unit 30 for controlling the first pressure value. Namely, the systolic pressure of the blood flow simulation system according to the present invention is controlled by controlling the first pressure value of the first pressure adjustment unit 30 by the control unit 20.

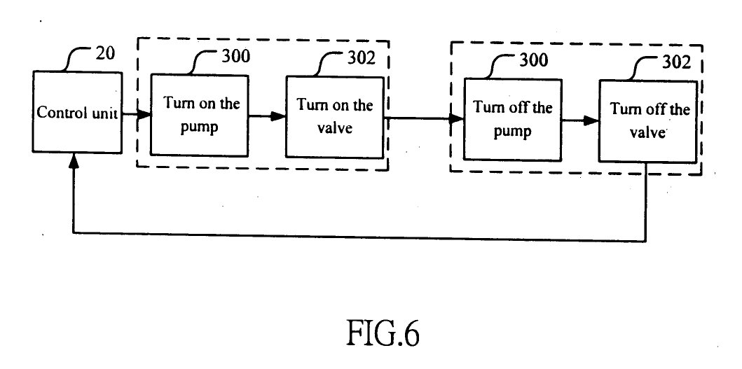

In addition, the first pressure adjustment unit includes a pump 300 and a valve 302. The pump 300 is connected to the first container 10, and transports the fluid to the phantom 12 according to the first pressure value. That is, the present invention uses the pump 300 to control the out-flowing of the fluid and thus to control the systolic pressure. The valve 302 is connected to the pump 300 and is controlled by the control unit 20. By controlling the switching sequence and timing, the pump 300 and the valve 302 are controlled and the blood-pressure waveform can be simulated. The control process first turns on the pump 300. After a period of time, the pressure of the fluid is raised, and the control unit 20 turns on the valve 302 to let the fluid pass. Then after a period of time, the control unit 20 turns off the pump 300 and the valve 302. By repeating the process described above, the blood-pressure signal can be simulated. Meanwhile, by changing the time period, the blood-pressure period (heart rate) can be changed as well as shown in FIG. 6. The valve 302 can be an electromagnetic valve, and is mainly used for simulating the on-off function of the heart valves.

The second pressure adjustment unit is set between the phantom 12 and the second container 14, and outputs the fluid according to a second pressure value. The control unit 20 is connected to the second pressure adjustment unit and controls the second pressure value. The second pressure adjust unit 32 has the second artificial blood vessel 122, and is located between the phantom 12 and the second container 14 for adjusting the pressure. Thereby, the second pressure value of the second pressure adjustment unit 32 can be controlled by the control unit 20, and the diastolic pressure of the blood flow simulation system can be adjusted. The second pressure adjustment unit 32 can be a pump or an adjustable flow-control clamp for artificial blood vessels.

The blood flow simulation system according to the present invention further comprises a pressure sensor 40. The pressure sensor 40 is used for sensing the first pressure value or the second pressure value, producing a first sensing signal and a second sensing signal, and transmitting to the control unit 20. Thereby, by transmitting the first and second sensing signals to the control unit 20, the simulated blood-vessel characteristics and blood-flow characteristics by the blood flow simulation system according to the present invention can be compared with expected characteristics. The blood flow simulation system can then be adjusted according to the first and the second sensing signals. Besides, the pressure sensors 40 can be set before the phantom 12 for sensing the first or the second pressure values and producing a first sensing signal or a second sensing signal. The pressure sensor 40 can also be set after the phantom 12 for sensing the first or the second pressure values and producing a first sensing signal or a second sensing signal. The pressure sensor 40 can even be set in the phantom 12 (not shown in the figure) for sensing pressure values.

The blood flow simulation system according to the present invention can be applied to calibrating general blood-pressure measuring devices in the market. The systolic and diastolic pressures to be simulated by the blood flow simulation system are preset first. Then the blood-pressure measuring device under test is used to measure phantom 12 and gives the systolic and diastolic pressures. Afterwards, the measured systolic and diastolic pressures are compared with the preset systolic and diastolic pressures. Accordingly, the blood-pressure measuring device under test can be calibrated.

The blood flow simulation system according to the present invention further comprises a flow meter 42. The flow meter is used for sensing a flow rate in the phantom 12, producing a third sensing signal, and transmitting the third sensing signal to the control unit 20. In addition, the flow meter 42 is set between the phantom 12 and the second container 14 for sensing the flow rate of the phantom 12 and producing the third sensing signal.

To sum up, the blood flow simulation system according to the present invention contains a fluid by a first container. Then a phantom is used for transporting the fluid. Afterwards, a second container is used for containing the fluid output by the phantom, and transporting the fluid to the first container by way of the phantom. Thereby, the blood-vessel characteristics, the blood-flow characteristics, and the human muscle characteristics can be simulated effectively and hence facilitating experimental convenience.

Accordingly, the present invention conforms to the legal requirements owing to its novelty, non-obviousness, and utility. However, the foregoing description is only a preferred embodiment of the present invention, not used to limit the scope and range of the present invention. Those equivalent changes or modifications made according to the shape, structure, feature, or spirit described in the claims of the present invention are included in the appended claims of the present invention.

1. A blood flow simulation system, comprising:
a first container, containing a fluid;
a phantom, transporting the fluid; and
a second container, containing the fluid output by the phantom, and transporting the fluid to the first container by way of the phantom.

2. The blood flow simulation system of claim 1, wherein the first container includes:
a housing, used for containing the fluid; and
a buffer structure, set in the housing for buffering the fluid.

3. The blood flow simulation system of claim 2, wherein the buffer structure includes:
a first partition, set in the housing, and located at the bottom of the housing; and
a second partition, set in the housing, located at the top of housing, and separated with the first partition by a distance.

4. The blood flow simulation system of claim 2, wherein the first container further includes a pressure-producing unit connected to the housing and providing a pressure to the housing.

5. The blood flow simulation system of claim 4, and further comprising a control unit, coupled to the pressure-producing unit for controlling the pressure.

6. The blood flow simulation system of claim 4, wherein the pressure-producing unit is an air-pressure-producing unit.

7. The blood flow simulation system of claim 1, wherein the first container is an airtight container.

8. The blood flow simulation system of claim 1, wherein the second container includes:
a housing, used for containing the fluid; and
a buffer structure, set in the housing for buffering the fluid.

9. The blood flow simulation system of claim 8, wherein the buffer structure includes:
a first partition, set in the housing, and located at the bottom of the housing; and
a second partition, set in the housing, located at the top of housing, and separated with the first partition by a distance.

10. The blood flow simulation system of claim 8, wherein the second container further includes a pressure-producing unit connected to the housing and providing a pressure to the housing.

11. The blood flow simulation system of claim 10, and further comprising a control unit, coupled to the pressure-producing unit for controlling the pressure.

12. The blood flow simulation system of claim 10, wherein the pressure-producing unit is an air-pressure-producing unit.

13. The blood flow simulation system of claim 1, wherein the second container is an airtight container.

14. The blood flow simulation system of claim 1, and further comprising:
a pressure adjustment unit, set between the first container and the phantom, and transporting the fluid according a pressure value; and
a control unit, connected to the pressure adjustment unit for controlling the pressure value.

15. The blood flow simulation system of claim 14, wherein the pressure adjustment unit includes a pump connected to the first container and transporting the fluid according to the pressure value.

16. The blood flow simulation system of claim 15, wherein the pressure adjustment unit further includes a valve connected to the pump and controlled by the control unit.

17. The blood flow simulation system of claim 16, wherein the valve is an electromagnetic valve.

18. The blood flow simulation system of claim 14, and further comprising a pressure sensor, used for sensing the pressure value, producing a sensing signal, and transmitting the sensing signal to the control unit.

19. The blood flow simulation system of claim 18, wherein the pressure sensor is set before the phantom for sensing the pressure value and producing the sensing signal.

20. The blood flow simulation system of claim 18, wherein the pressure sensor is set after the phantom for sensing the pressure value and producing the sensing signal.

21. The blood flow simulation system of claim 18, wherein the pressure sensor is set in the phantom for sensing the pressure value and producing the sensing signal.

22. The blood flow simulation system of claim 1, and further comprising a flow meter for sensing a flow rate in the phantom, producing a sensing signal, and transmitting the sensing signal to the control unit.

23. The blood flow simulation system of claim 22, wherein the flow meter is set between the phantom and the second container for sensing the flow rate in the phantom and producing the sensing signal.

24. The blood flow simulation system of claim 1, and further comprising a pressure adjustment unit, set between the phantom and the second container, and transporting the fluid according a pressure value.

25. The blood flow simulation system of claim 24, and further comprising a control unit, connected to the pressure adjustment unit for controlling the pressure value.

26. The blood flow simulation system of claim 24, wherein the pressure adjustment unit can be a pump or an adjustable flow-control clamp for artificial blood vessels.

27. The blood flow simulation system of claim 24, and further comprising a pressure sensor, used for sensing the pressure value, producing a sensing signal, and transmitting the sensing signal. to the control unit.

28. The blood flow simulation system of claim 27, wherein the pressure sensor is set before the phantom for sensing the pressure value and producing the sensing signal.

29. The blood flow simulation system of claim 27, wherein the pressure sensor is set after the phantom for sensing the pressure value and producing the sensing signal.

30. The blood flow simulation system of claim 27, wherein the pressure sensor is set in the phantom for sensing the pressure value and producing the sensing signal.

31. The blood flow simulation system of claim 1, wherein the phantom includes:
a plurality of artificial blood vessels, transporting the fluid; and
a contact part, used for covering the plurality of artificial blood vessels.

32. The blood flow simulation system of claim 31, wherein the artificial blood vessel is a rubber tube or a polymer tube.

33. The blood flow simulation system of claim 31, wherein the contact part is made from silicone elastomer or gels.
